(19) United States
(12) Patent Application Publication
(10) Pub. No.: US 2008/0246755 A1
(43) Pub. Date: Oct. 9, 2008

(54) Display, Column Driver Integrated Circuit, and Multi-Level Detector, and Multi-Level Detection Method

(76) Inventor: Yong-Jae Lee, Gyeonggi-do (KR)

Correspondence Address: SHERR & VAUGHN, PLLC, 620 HERNDON PARKWAY, SUITE 200, HERNDON, VA, 20170, US

(21) Appl. No.: 12/066,550

(22) PCT Filed: Nov. 3, 2005
(86) PCT No.: PCT/KR05/03679

§ 371 Date: Mar. 12, 2008

(30) Foreign Application Priority Data
Sep. 23, 2005 (KR) 10-2005-0088611

(51) Int. Cl. G09G 5/00

(52) U.S. Cl. 345/214

(57) ABSTRACT

The present invention relates to a display, a column driver integrated circuit, and a multi-level detector, and multi-level detection method, and more particularly to a multi-level detector, multi-level detection method, a display and column driver integrated circuit reducing a possibility of an error by removing the common mode from the received multi-level signal. The present invention provides a multi-level detector including a common mode removing circuit for removing a common mode of a differential multi-level signal, and a first and a second comparators for detecting multi-level using the differential multi-level signal being removed of the common mode. The present invention further provides a display and a column driver integrated circuit including the multi-level detector

### TECHNICAL FIELD

The present invention relates to a display, a column driver integrated circuit, and a multi-level detector, and multi-level detection method, and more particularly to a multi-level detector, multi-level detection method, a display and column driver integrated circuit reducing a possibility of an error by removing the common mode from the received multi-level signal.

### BACKGROUND ART

Recently, in addition to an increase in a popularization of portable electronic devices such as a notebook computer and a personal portable communication device, a market size of digital appliances and personal computers is constantly increased. Display apparatuses which are final connection medium between such devices and users is required to have a light weight and low power consumption. Therefore, FPDs (Flat Panel Displays) such as an LCD (Liquid Crystal Display), a PDP (Plasma Display Panel) and an OELD (Organic Electro-Luminescence Display) are generally used instead of a conventional CRT (Cathode Ray Tube).

### DISCLOSURE OF INVENTION

### Technical Problem

As described above, in case of generalized FPD system, a timing controller and a driver IC for driving panel (scan driver integrated circuit and column driver integrated circuit) are required for driving a panel that is used for display. However, a large amount of a problematic wave interference caused in an electronic device by an electromagnetic wave and a radio frequency wave so-called an EMI (electromagnetic interference) or an RFI (radio frequency interference) (hereinafter commonly referred to as “EMI”) is generated in a line for transmitting a data signal between the timing controller and the driver IC for driving panel.

Moreover, in case of current FPD system, a large screen and a high resolution are constantly pursued, and in case of a high resolution panel in particular, since the number of a column line is from a few hundreds to two thousand, an input to the column driver integrated circuit for driving each of these lines requires a high speed data transmission technology.

As described above, since an EMI standard is reinforced recently, and a technology for transmitting a signal in a high speed is far more required, a small signal differential signaling method such as an RSDS (Reduced Swing Differential Signaling) or a mini-LVDS is commonly used in an intra-panel display for connecting the timing controller and the panel resultantly.

FIG. 1 is a schematic diagram illustrating an embodiment of a conventional RSDS(Reduced Swing Differential Signaling), and FIG. 2 is a schematic diagram illustrating an embodiment of a conventional mini-LVDS(Low Voltage Differential Signaling). The RSDS and mini-LVDS both comprise one or more data signal lines to meet a required bandwidth using a separate clock signal synchronized to a data. Since only one clock signal is used, the clock signal and the data signals must be provided to match the number of the column driver integrated circuits 20 and 21 inside the panel. That is, as shown in FIGS. 1 and 2, the RSDS and the mini-LVDS both employ a multi-drop method.

However, the multi-drop method employed by both the RSDS and the mini-LVDS is disadvantageous in that a maximum operating speed is limited due to a large load of the clock signal as well as an increase in EMI and degradation of quality of the signal such as a signal distortion due to impedance mismatch at a point where lines are split.

An intra-panel interface employing a point-to-point method recently announced by National Semiconductor Corporation is a PPDS (Point-to-Point Differential Signaling). In accordance with this method shown in FIG. 3, clock signals are transmitted to each of column driver integrated circuits 22 to solve a problem that occurs when the clock signal is shared by the column driver integrated circuit 22. Moreover, this method is characterized in that an independent data line is disposed between a timing controller and a single column driver integrated circuit 22 while a plurality of data lines are connected to a plurality of column driver integrated circuits conventionally. That is, as a serial method is employed to the PPDS as shown in FIG. 3, a single independent data line is disposed from a PPDS timing controller 12 toward the single column driver integrated circuit 22.

Therefore, the impedance mismatch is reduced compared to the conventional multi-drop method employed by the RSDS and the mini-LVDS so that EMI is reduced and a low manufacturing cost is achieved by reducing the number of total signal line.

However, a higher speed clock signal compared to the conventional RSDS is required, and separate clock lines are connected to all of the column driver integrated circuit respectively so that an overhead exists. Moreover, when a skew between a clock signal for sampling data and a data signal exists, an error may occur during a data sampling process. In order to prevent this, a separate circuit for compensating the skew is necessary. Therefore, the PPDS has problems different from the conventional RSDS and the mini-LVDS that should be solved.

In addition, as shown in FIG. 4, a configuration wherein a column driver integrated circuit 23 receives a clock signal in a chain form has been recently proposed. Such configuration is advantageous in that an impedance mismatch due to a multi-drop of a clock line and a resulting EMI can be reduced. However, this configuration is problematic that a data sampling is failed due to a delay of a clock occurring between the column driver integrated circuit 23.

As described above, the latest trend in the intra-panel interface is focused on reducing the number of signal lines and EMI component. In addition, an operating speed and a resolution of a panel are increased compared with the reduction of the number of signal lines so that a novel intra-panel interface that can solve problems such as the skew and the relative jitter occurring during a high speed signal transmission process is required.

### Technical Solution

It is an object of the present invention to provide a display and a column driving integrated circuit wherein the number of the signal lines is remarkably reduced, the EMI is also reduced and the accurate sampling is possible using the restored clock.

It is yet another object of the present invention to provide a display, a column driving integrated circuit, a multi-level detector and a multi-level detection method which reduce a possibility of an error by removing the common mode from the received multi-level signal.

In accordance with first aspect of the present invention, there is provided a multi-level detector comprising: a first common mode removing circuit for receiving a first differential multi-level signal including a first signal and a second signal, and outputting a second differential multi-level signal including a third signal and a fourth signal, wherein the second differential multi-level signal is generated by removing a common mode of the first differential multi-level signal; a first comparator for receiving the second differential multi-level signal and a differential reference signal including a first reference signal and a second reference signal having a voltage value lower than that of the first reference signal and for outputting one of two logic values according to a result of a comparison of a voltage of the third signal and a voltage of the first reference signal and to a result of a comparison of a voltage of the fourth signal and a voltage of the second reference signal; a second comparator for receiving the second differential multi-level signal and the differential reference signal and for outputting one of the two logic values according to a result of a comparison of the voltage of the fourth signal and the voltage of the first reference signal and to a result of a comparison of the voltage of the third signal and the voltage of the second reference signal; and an arithmetic unit for outputting a multi-level detection result, wherein the multi-level detection result is a result of a logic operation of outputs of the first and the second comparator.

In accordance with second aspect of the present invention, there is provided a multi-level detecting method, comprising steps of: (a) removing a common mode of a received differential multi-level signal; and (b) outputting a result of a comparison between the received differential multi-level signal having the common mode thereof removed and a voltage of a first differential reference signal.

In accordance with third aspect of the present invention, there is provided a column driving integrated circuit comprising a shift register, a data latch and a DAC, the integrated circuit further comprising: a first common mode removing circuit for outputting a differential signal generated by removing a common mode of a received differential signal consisting of a first signal and a second signal, the differential signal consisting of a third signal and a fourth signal; a data detecting unit for outputting a received data signal corresponding to a sign of the received differential signal or the differential signal; a clock detecting unit for outputting a received clock signal wherein the received clock signal is a result of a comparison between voltages of the differential signal and a first differential reference signal, the first differential reference signal consisting of a first reference signal and a second reference signal having a voltage lower than that of the first reference signal; and a sampler for performing a sampling of the received data signal using the received clock signal to transmit a sampled result to the shift register.

In accordance with fourth aspect of the present invention, there is provided a display comprising a timing controller, a plurality of column driving integrated circuits, at least one row driving integrated circuit and a display panel, wherein the plurality of column driving integrated circuits include a column driving integrated circuit in accordance with the third aspect of the present invention.

### Advantageous Effects

As described above, in accordance with the display and the column driving integrated circuit, the number of the signal lines are remarkably reduced, the EMI is also reduced and the accurate sampling is possible using the restored clock as well.

In addition, the display, the column driving integrated circuit and the multi-level detector reduce a possibility of an error by removing the common mode from the received multi-level signal.

### BRIEF DESCRIPTION OF THE DRAWINGS

FIG. 1 is a schematic diagram illustrating an embodiment of a conventional RSDS(Reduced Swing Differential Signaling).

FIG. 2 is a schematic diagram illustrating an embodiment of a conventional mini-LVDS(Low Voltage Differential Signaling).

FIG. 3 is a schematic diagram illustrating an embodiment of a conventional PPDS(Point-to-Point Differential Signaling).

FIG. 4 is a schematic diagram illustrating a method for receiving a clock signal in series from a neighboring column driver integrated circuit in the RSDS in series wherein the column driver integrated circuit is configured to have a chain structure.

FIG. 5 is a diagram illustrating a structure of a clock embedded intra-panel display in accordance with a first embodiment of the present invention.

FIG. 6 is a diagram illustrating only a transmission structure of a clock and a data between a timing controller and column driver integrated circuits of FIG. 5 for convenience of comprehension.

FIGS. 7 through 10 is diagrams illustrating examples of a multi-level signaling that can be used for an interface between the timing controller and the column driver integrated circuits of FIG. 5.

FIG. 11 is a diagram illustrating a structure of a clock embedded intra-panel display in accordance with a second embodiment of the present invention.

FIG. 12 is a diagram illustrating only a transmission structure of a clock and a data between a timing controller and column driver integrated circuits of FIG. 11 for convenience of comprehension.

FIG. 13 is a diagram illustrating an example of a timing controller that can be used for the display of FIG. 5 or FIG. 11.

FIG. 14 is a diagram illustrating an example of a column driver integrated circuit that can be used for the display of FIG. 5 or FIG. 11.

FIG. 15 is a diagram illustrating another example of a timing controller that can be used for the display of FIG. 5 or FIG. 11.

FIG. 16 is a diagram illustrating another example of a column driver integrated circuit that can be used for the display of FIG. 5 or FIG. 11.

FIG. 17 is a diagram illustrating an example of a multi-level detector that may be employed by the column driving integrated circuit of FIG. 14 or 16.

FIG. 18 is a diagram illustrating an example of a third comparator of FIG. 17.

FIG. 19 is a diagram illustrating an example of a first and a second comparators of FIG. 17.

FIG. 20 is a signal diagram illustrating a problem of the multi-level detector of FIG. 17.

FIG. 21 is a diagram illustrating another example of a multi-level detector that may be employed by the column driving integrated circuit of FIG. 14 or 16, wherein a malfunction of the multi-level detector does not occur even when a received signal has a common mode.

FIG. 22 is a diagram illustrating an example of a first common mode removing circuit of FIG. 21.

FIG. 23 is a diagram illustrating yet another example of a multi-level detector that may be employed by the column driving integrated circuit of FIG. 14 or 16, wherein the multi-level detector which removes the common mode of the reference signal as well as the received signal and then detects a clock signal is illustrated.

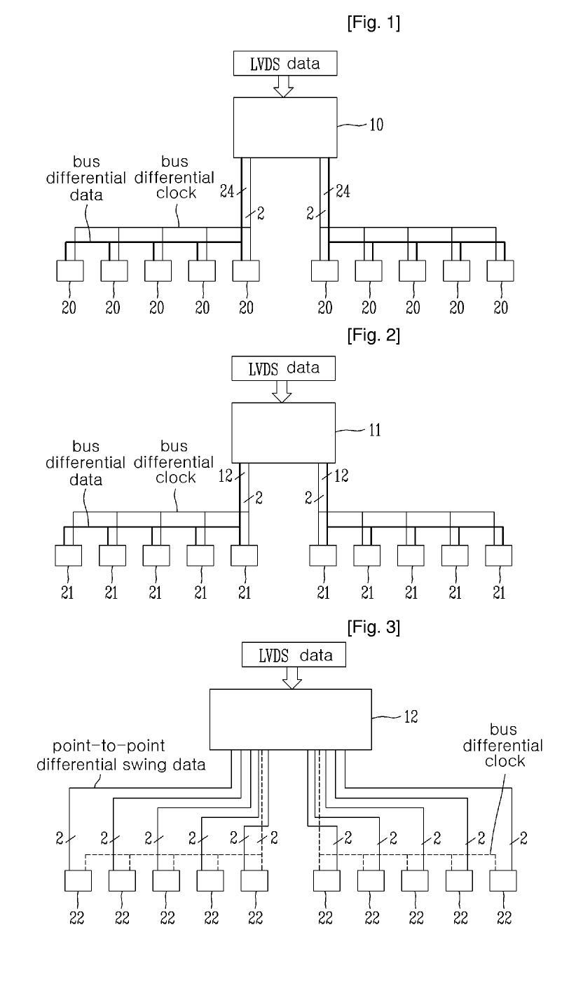

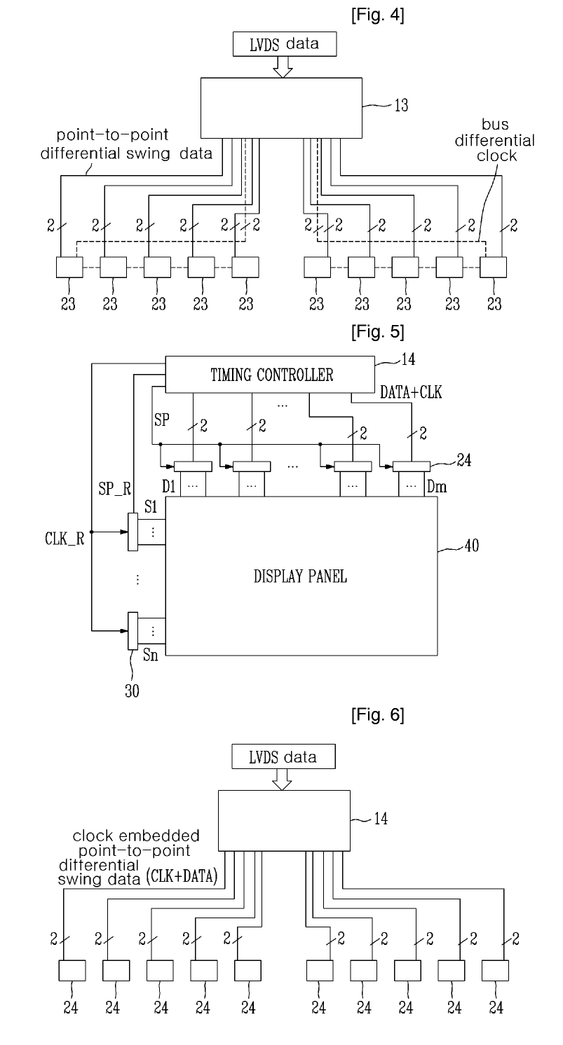

10: RSDS timing controller

11: mini-LVDS timing controller

12, 13: PPDS timing controller

14, 15: timing controller used for clock embedded multi-level signaling method

20: RSDS column driver IC

21: mini-LVDS column driver IC

22, 23: PPDS column driver IC

24, 25: column driver integrated circuit used for clock embedded multi-level signaling method

30: row driving IC

40: display panel

51, 71: receiving unit of timing controller

52, 72: buffer memory

53, 73: timing controller circuit

54, 74: transmitter

55, 75: demultiplexer

56, 76: serial converter

57, 77: driving unit

61, 81: receiving unit of column driver IC

62, 82: shift register

63, 83: data latch

64, 84: DAC

65, 85: reference voltage generator

66, 86: multi-level detector

67, 87: clock restoring circuit

68, 88: sampler

69, 89: data aligning unit

91: clock detector

92: data detector

93: first comparator

94: second comparator

95: arithmetic unit

96: third comparator

97: first common mode removing circuit

98, 100: differential amplifier

99: second common mode removing circuit

### BEST MODE FOR CARRYING OUT THE INVENTION

The present invention will now be described in detail with reference to the accompanied drawings. The interpretations of the terms and wordings used in Description and Claims should not be limited to common or literal meanings. The interpretation should be made to meet the meanings and concepts of the present invention based on the principle that the inventor or inventors may define the concept of the terms so as to best describe the invention thereof. Therefore, while the present invention has been particularly shown and described with reference to the preferred embodiment thereof, it will be understood by those skilled in the art that various changes in form and details may be effected therein without departing from the spirit and scope of the invention as defined by the appended claims.

In accordance with the present invention, a conventional multi-level signaling method is applied so as to provide a novel coding method wherein a clock signal information is embedded between data signals without and instead of a separate clock signal line, thereby resolving problems of conventional technologies such an impedance mismatching due to a multi-drop of a data line and a clock line and a resulting EMI.

In addition, in accordance with the present invention, the clock signal component can facilely extracted from the clock signal embedded in the data signal line using a multi-level detection method, and the clock signal component is only one-tenths of a frequency necessary for sampling of an actual data. Therefore, this plays a major role in reducing EMI of an entire system since the frequency is small, and a relative jitter or skew problem generated when the data signal and the clock signal are separate can be prevented to perform a stable operation in a high speed.

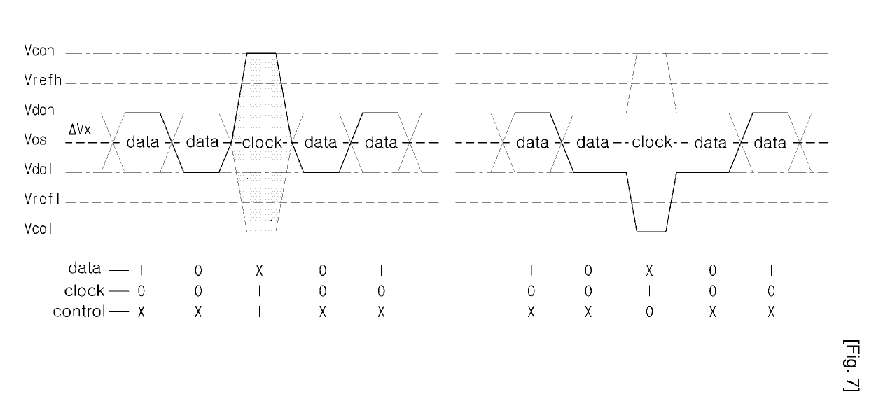

FIG. 5 is a diagram illustrating a structure of a clock embedded intra-panel display in accordance with a first embodiment of the present invention, and FIG. 6 is a diagram illustrating only a transmission structure of a clock and a data between a timing controller and column driver integrated circuits of FIG. 5 for convenience of comprehension. Referring to FIGS. 5 and 6, a display comprises a timing controller 14, a plurality of column driver integrated circuits 24, a plurality of row driver integrated circuits 30 and a display panel 40. A driving apparatus for the display panel 40 comprises the timing controller 14, the plurality of column driver integrated circuits 24 and the plurality of row driver integrated circuits 30.

The display panel 40 serves as a part for displaying an image according to a scanning signal and a data signal and may be selected from various display panels such as a LCD panel, a PDP panel and an OELD panel. The plurality of row driver integrated circuits 30 apply scan signals S1 through Sn to the display panel 40, and the plurality of column driver integrated circuits 24 applies data signals D1 through Dn to the display panel 40. The timing controller 14 transmits DATA to the plurality of column driver integrated circuits 24, and applies clocks CLK and CLK_R and start pulses SP and SP_R to the plurality of column driver integrated circuits 24 and the plurality of row driver integrated circuits 30. DATA transmitted from the timing controller 14 to the plurality of column driver integrated circuits 24 may comprises only an image data that is to be displayed on the display panel 40 or the image data and a control signal.

Contrary to the conventional technology, in accordance with the first embodiment of the present invention, only one pair of differential pair is used to transmit the clock CLK and the data signal DATA from the timing controller 14 to the column driver integrated circuit 24. The clock signal CLK is embedded between the data signal DATA to have a different signal magnitude at the timing controller 14 which is a transmitting terminal and transmitted. The clock signal CLK is distinguished from the data signal DATA using the magnitude of a received signal at the column driver integrated circuit 24 which is a receiving terminal.

FIG. 7 is a diagram illustrating an example of a multi-level signaling that can be used for an interface between the timing controller and the column driver integrated circuits of FIG. 5. Referring to FIGS. 5 through 7, the timing controller 14 converts the data to a signal having a smaller voltage than that of a predetermined reference voltage, a clock to a signal having a larger voltage than that of the predetermined reference voltage, and embeds the converted clock signal between the converted data signal to multiplex and then transmits. In addition, values of the data signals can be obtained at the column driver integrated circuit 24 which is the receiving terminal by a differential signal processing well-known in the art, and the clock signal is distinguished using Vrefh and Vrefl. That is, when an absolute value of difference between two input signals |Vin,p−Vin,n| is smaller than a magnitude of the reference signal |Vrefh−Vrefl|, the two input signals are processed as the data signal. Therefore, when Vin,p is larger than Vin,n, the data values is set to 1 and when Vin,p is smaller than Vin,n, the data values is set to 0. When the absolute value of difference between the two input signals is larger than the magnitude of the reference signal (|Vin,p−Vin,n|>|Vrefh−Vrefl|), the two input signals are recognized as the clock.

As shown in the figures, since a frequency of an actually embedded clock is lower than a transmission speed of the data, the receiving terminal generates a clock signal having the same speed as that of the data using a PLL (not shown), and the data is sampled using the same. In an aspect of an EMI of the system, the most important factor is the clock signal, and a magnitude of the EMI is known to be proportional to a magnitude and a frequency of the clock signal. Therefore, in accordance with the present invention, the frequency of the clock may be reduced to 1/10 or 1/20 of the conventional PPDS system, thereby remarkably reducing EMI.

In addition, when the clock is restored from the data and the clock signal configuration shown in the figures, the clock is restored in a naturally synchronized state with the data. Therefore, when a sampling is performed using the restored clock, it is advantageous in that the data sampling may be performed more accurately compared to the conventional LVDS, mini-LVDS and PPDS.

Moreover, as shown in the figures, while the number of combinations of signals that can actually be represented is four, the desired signals are two data signals and one click signal. Therefore, when an absolute value of difference between two input signals |Vin,p−Vin,n| is larger than a magnitude of the reference signal |Vrefh−Vrefl|, the clock signal is unconditionally generated while a separate control signal or an image data may be transmitted simultaneously using sign of the two signals. When the sign is positive, it is recognized that 1 is applied, and when the sign is negative, it is recognized that 0 is applied.

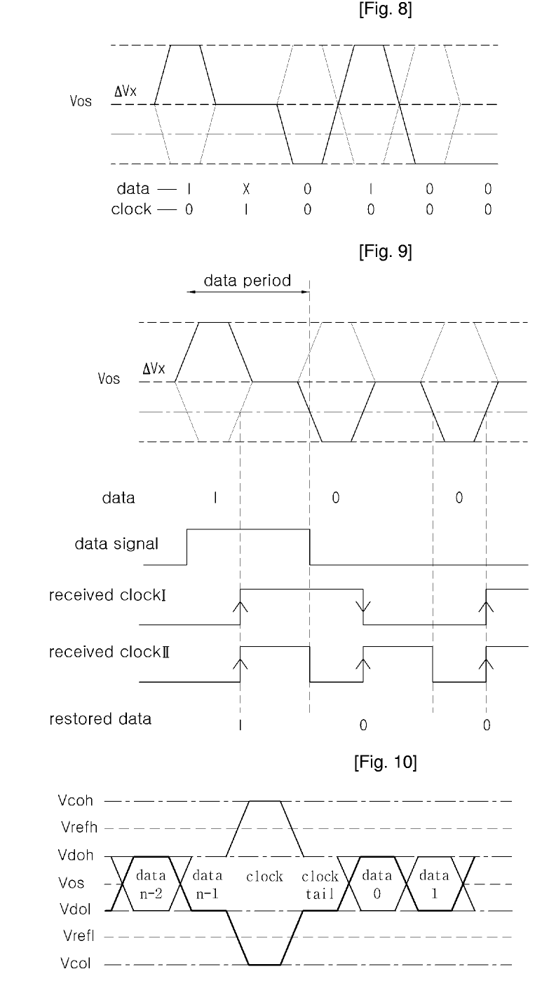

FIG. 8 is a diagram illustrating another example of a multi-level signaling that can be used for an interface between the timing controller and the column driver integrated circuits of FIG. 5.

Referring to FIGS. 5, 6 and 8, the timing controller 14 converts the data to a signal having a larger voltage than that of a predetermined reference voltage, a clock to a signal having a smaller voltage than that of the predetermined reference voltage, and embeds the converted clock signal between the converted data signal to multiplex and then transmits. In addition, the column driver integrated circuit 24 which is a receiving terminal restores a received signal to the data when a voltage of the received signal is larger than that of a reference voltage and to the clock when the voltage of the received signal is smaller than that of the reference voltage.

As shown in the figures, since the clock signal does not have a concept such as 1 and 0 contrary to the data, a three multi-level is sufficient for the multi-level signaling. That is, when an absolute value of difference between two input signals |Vin,p−Vin,n| is larger than a magnitude of the reference signal |Vrefh−Vrefl|, the two input signals are recognized as the data signal, and the data is recognized as 1 or 0 according to a sign of the data signal. On the contrary, when an absolute value of difference between two input signals |Vin,p−Vin,n| is smaller than a magnitude of the reference signal |Vrefh−Vrefl|, the two input signals are recognized as the clock signal. Therefore, contrary to the method of FIG. 7 which requires 3ΔVx (ΔVx refers to a noise margin) voltage operation due to requirement of four multi-level, the method of FIG. 8 may be operated at a low voltage of 2ΔVx since three multi-levels are sufficient for the method of FIG. 8.

FIG. 9 is a diagram illustrating yet another example of a multi-level signaling that can be used for an interface between the timing controller and the column driver integrated circuits of FIG. 5.

In case of examples shown in FIGS. 7 and 8, although the clock signal is transmitted with the data, a clock restoring circuit consisting of a DLL, a PLL or the like is required at the receiving terminal as the clock signal does not exist for every data. A column driver integrated circuit of a large LCD is not affected by an increase in an area or a current due to DLL and the like. However, in case of a column driver integrated circuit of a small LCD, these may be problematic. Moreover, when the a transmission speed of the data is not very high, it is advantageous to configure the clock restoring circuit to be simple by transmitting the clock with every data.

The method shown in FIG. 9 is to resolve these problems. Although the method shown in FIG. 9 is similar to FIGS. 7 and 8 in the aspect of multi-level, it differs in that the clock signal is transmitted during a period corresponding to one half of the data period. When an absolute value of difference between two input signals |Vin,p−Vin,n| is larger than a magnitude of the reference signal |Vrefh−Vrefl|, the two input signals are recognized as the data signal, and the data is recognized as 1 or 0 according to a sign of the data signal. On the contrary, when an absolute value of difference between two input signals |Vin,p−Vin,n| is smaller than a magnitude of the reference signal |Vrefh−Vrefl|, the two input signals are unconditionally recognized as the clock signal.

As shown in the restored data and clock signal, the clock signal is positioned in a middle of each data transition period. The object of the clock restoring circuit is to place the clock at a most ideal position for sampling, i.e. in the middle of the data transition period, and it is obvious that the signal configuration of the present invention satisfies this. That is, the period of the data signal is halved while the length of the clock signal is configured to be identical to that of the data so that the clock signal is restored for each of the data at the receiving terminal. Through such process, the received data signal can be restored by a simple sampling circuit.

In accordance with the structure shown in FIG. 9, a sign of the received data is changed only when the received data is beyond a threshold value. That is, the value is changed according to the sign of the data only when an absolute value of a difference of two input signals |Vin,p−Vin,n| is larger than a magnitude of the reference signal |Vrefh−Vrefl|.

Contrary to this, two configurations are possible for the clock. Firstly, similar to the data, in case a polarity is changed only when an absolute value of a difference of two input signals |Vin,p−Vin,n| is smaller than a magnitude of the reference signal |Vrefh−Vrefl|, the data may be sampled at both a rising edge and a falling edge of the clock signal. Secondly, contrary to the above case, when case of the absolute value of the difference of the two input signals |Vin,p−Vin,n| being larger than a magnitude of the reference signal |Vrefh−Vrefl| and case of the absolute value of the difference of the two input signals |Vin,p−Vin,n| being smaller than a magnitude of the reference signal |Vrefh−Vrefl| are regarded as a transition period of the clock, the data is sampled at the rising edge of the clock signal as shown in FIG. 9.

Although description has been focused on a case of the clock signal being smaller than the data signal referring to FIG. 9, embedding the clock signal to each of the data signal may be applied when the magnitude of the clock signal is larger than that of the data signal, which can be facilely understood by a person skilled in the art. Therefore, a detailed description regarding this matter is omitted.

FIG. 10 is a diagram illustrating yet another example of a multi-level signaling that can be used for an interface between the timing controller and the column driver integrated circuits of FIG. 5.

Referring to FIG. 10, a polarity of the clock signal follows that of a previous data. That is, a data n-1 and the clock have the same polarity, and a tail bit of the clock is added to additionally generate a signal of a dummy data identical to the previous data signal (data n-1).

A sufficient rising time and falling time can be obtained through the dummy data. The dummy data is added to prevent the clock from being speeded up or delayed depending on a form of the previous data in case of FIG. 7. Therefore, in such case, because a possibility of generation of a jitter due to a slew rate between a transition of the data and a transition which is recognized as the clock signal is waived, it is advantageous in that a stable operation is secured in high speed transmission.

That is, while a position of a zero-crossing for generating the clock signal is dependent on a value of the previous data in case of FIG. 7, it is advantageous in that zero-pattern dependent jitter is not generated in case of FIG. 10.

### MODE FOR THE INVENTION

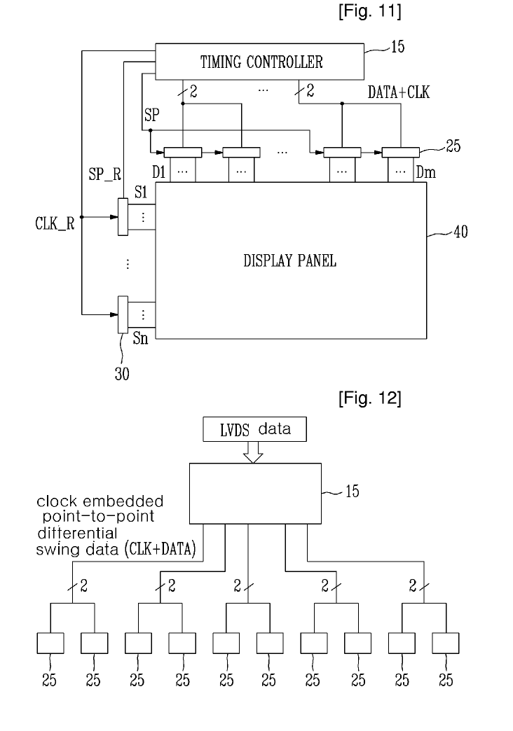

FIG. 11 is a diagram illustrating a structure of a clock embedded intra-panel display in accordance with a second embodiment of the present invention, and FIG. 12 is a diagram illustrating only a transmission structure of a clock and a data between a timing controller and column driver integrated circuits of FIG. 11 for convenience of comprehension.

Comparing the first embodiment and the second embodiment, the second embodiment employs a point-to-couple scheme while the first embodiment point-to-point scheme. Since the second embodiment is identical to the first embodiment except that the second embodiment employs the point-to-couple scheme, the multi-level signaling method that may be used for an interface between the timing controller and the column driver integrated circuit described referring to FIGS. 7 through 10 may be applied to the second embodiment. However, while one differential pair is connected to one column driver integrated circuit in case of the first embodiment, one differential pair is connected to two column driver integrated circuits 25 in case of the second embodiment. Therefore, an amount of data transmitted through the differential pair in case of the second embodiment is increased to twice as much as an amount in case of the first embodiment.

The reason a signal line of a start pulse SP transmitted from a timing controllers 14 and 15 to a column driver integrated circuits 24 and 25 is denoted in dotted line in FIGS. 5 and 11 is that the signal line of the start pulse SP is not used in some cases. Specifically, the signal line of the start pulse SP is necessary when only a clock signal CLK and an image data are transmitted through the differential pair while the signal line of the start pulse SP is necessary when the clock signal CLK, the image data and a control signal including the start pulse SP are transmitted through differential pair. In this case, the control signal may be included in a data signal DATA when being transmitted. In addition, when a magnitude of the clock signal is larger than that of the data signal, the control signal may be transmitted using a polarity of the clock signal. For example, of data signals corresponding to a predetermined row line, a clock signal positioned prior to a data transmitted to the column driver integrated circuit for the first time may have a polarity corresponding to 1, and other clock signals may have a polarity corresponding to 0.

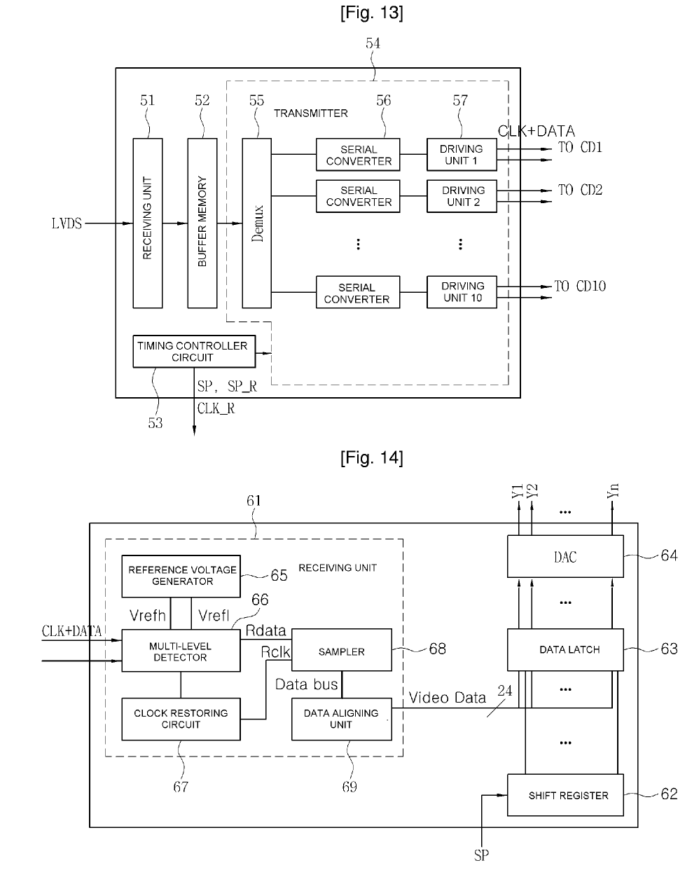

FIG. 13 is a diagram illustrating an example of a timing controller that can be used for the display of FIG. 5 or FIG. 11. In accordance with the example, a case where the start pulse is transmitted through a signal line separate from the differential pair is exemplified. Referring to FIG. 13, the timing controller comprises a receiving unit 51, a buffer memory 52, a timing controller circuit 53 and a transmitter 54.

The receiving unit 51 converts an image data signal and a received control signal being input to the timing controller to a TTL(transistor-transistor logic) signal. The received control signal may be a start pulse, for example. The received signal being input to the timing controller is not limited to a signal of an LVDS type as shown in figure, but may be a signal of a TMDS (transition minimized differential signaling) type or other types. The TTL signal refers to a signal converted to digital, and has a large voltage magnitude contrary to the LVDS having a small magnitude of 0.35V.

The buffer memory 52 temporarily stores and outputs the image data converted to the TTL signal.

The timing controller circuit 53 receives a control signal converted to the TTL signal and generates a start pulse SP_R and a clock signal CLK_R transmitted to a row driving integrated circuit. The timing controller circuit 53 also generates the start signal SP to be transmitted to the column driver integrated circuit, and a clock to be used in the transmitter 54.

The transmitter 54 receives the image data being output from the buffer memory 52 and the clock signal being output from the timing controller circuit 53, and outputs the clock signal CLK and a data signal DATA to be transmitted to each column driver integrated circuit. The clock signal CLK and the data signal DATA are transmitted through the differential pair for each column driver integrated circuit, and the clock signal CLK is embedded between the data signal DATA to have a signal magnitude different from that of the data signal DATA. The transmitter 54 may embed the clock signal into each transmission data signals or may embed the transmission clock signal into every N transmission data signals (where N is an integer larger than 1). In addition, the transmitter 54 may transmit by setting a magnitude of the clock signal larger than that of the data signal or by setting the magnitude of the clock signal smaller than that of the data signal. When the magnitude of the clock signal is set to be larger than that of the data signal, the transmitter 54 may set a polarity of the embedded clock signal to be identical to that of the data signal immediately prior to the embedded clock signal, and inserts a dummy signal having a polarity identical to the data signal which is immediately prior to the embedded clock signal immediately after the embedded clock signal to prevent a jitter during a high speed transmission. In addition, when the magnitude of the clock signal is set to be larger than that of the data signal, the data signal may be transmitted using the polarity of the clock signal. The transmitter 54 comprises a demultiplexer 55, a serial converter 56 and a driving unit 57.

The demultiplexer 55 transmits the image data being output from the buffer memory 52 to the serial converter 56 by separating the image data into data for each column driver integrated circuit. When a plurality of the column driver integrated circuits are connected to a single differential pair, the demultiplexer 55 transmits the image data to the serial converter 56 by separating the image data into data for each column driver integrated circuit. When two column driver integrated circuits are connected to the single differential pair as shown FIG. 11, the demultiplexer 55 transmits the image data corresponding to the two column driver integrated circuits to a single serial converter 56.

The serial converter 56 sequentially outputs a clock bit and the image data being output from the demultiplexer 55 to the driving unit 57. For example, when a clock tail shown in FIG. 10 is used, the serial converter 56 outputs a DATAn-1, the clock bit having the polarity identical to that of the DATAn-1, a clock tail bit (dummy bit) having the polarity identical to that of the DATAn-1, and a DATA 0.

When a single clock signal is embedded for each image data corresponding to a single pixel, a depth of each of RGB is 8 bit, and the clock tail is used as shown in FIG. 10, a data being output from the serial converter 56 which includes the clock bit, clock tail and 24 bits of image data, 26 bits in total, is transmitted to the driving unit 57 per clock. In addition, when the clock tail bit is not used, a signal including the clock bit and 24 bits of image data, 25 bits in total, may be transmitted to the driving unit 57 for every clock, and when the data signal is transmitted using the polarity of the clock signal, a signal of 24 bits may be transmitted to the driving unit 57 for every clock because a separate clock bit is not required. In addition, the serial converter 56 may dispose the clock bit between every data bit so that the clock is transmitted for every data as shown in FIG. 9.

The driving unit 57 converts the signal sequentially being output from the serial converter 56 to a differential signal to be output wherein the clock signal and the data signal have different signal magnitudes. As described above, when a signal including the clock bit, clock tail and 24 bits of image data, 26 bits in total, is received, a signal of the clock bit is converted to have a different magnitude from the clock tail and the image data, and when a signal including the clock bit and 24 bits of image data, 25 bits in total, is received, the signal of the clock bit is converted to have a different magnitude from the image data. In addition, as described above, when the signal of 24 bits which does not include the separate clock bit is received, the data signal in a position corresponding to the clock is converted to have a magnitude different from that of other image data signal. The driving unit 57 may convert clock signal to have a magnitude larger than that of the data signal, or may convert clock signal to have a magnitude smaller than that of the data signal.

FIG. 14 is a diagram illustrating an example of a column driver integrated circuit that can be used for the display of FIG. 5 or FIG. 11. In accordance with the example, a case where the start pulse is transmitted through a signal line separate from the differential pair is exemplified. Referring to FIG. 14, the column driver integrated circuit comprises a receiving unit 61, a shift register 62, data latch 63 and a DAC (digital-to-analog converter) 64.

The receiving unit 61 restores the data signal DATA and the clock signal CLK from the signal transmitted through the single differential pair. Since the clock signal CLK is transmitted by being embedded between the data signal DATA to have a different magnitude, whether the transmitted signal is the clock signal CLK or the data signal DATA is determined using the magnitude of the signal. Thereafter, the receiving unit 61 performs a sampling of the received data signal DATA using the restored clock signal CLK. When the timing controller embeds the clock signal CLK for each data signal DATA for transmission, the clock signal CLK may be used for the sampling of the data signal as is without changing a frequency of the clock signal CLK. However, when the timing controller embeds the clock signal CLK for a plurality of the data signal DATA for transmission, a signal should be generated from the clock signal CLK using a PLL or a DLL and the sampling is then performed using the signal. The receiving unit 61 comprises a reference voltage generator 65, a multi-level detector 66 and a sampler 68. In addition, the receiving unit 61 may further comprise a clock restoring circuit 67 and a data aligning unit 69.

The reference voltage generator 65 generates and outputs differential reference signals Vrefh and Vrefl. The multi-level detector 66 separates the clock signal CLK and the data signal DATA from the received signal by comparing a magnitude of the received signal with reference voltage Vrefh and Vrefl. In case the timing controller embeds the clock signal to have a smaller magnitude than the data signal for transmission, the received signal is recognized as a data when an absolute value of the received differential voltage |Vin,p−Vin,n| is larger than a difference of the reference voltage |Vrefh−Vrefl|, and the received signal is recognized as a clock when the absolute value of the received differential voltage |Vin,p−Vin,n| is smaller than the difference of the reference voltage |Vrefh−Vrefl|. In case the timing controller embeds the clock signal to have a larger magnitude than the data signal for transmission, the received signal is recognized as a data when an absolute value of the received differential voltage |Vin,p−Vin,n| is smaller than a difference of the reference voltage |Vrefh−Vrefl|, and the received signal is recognized as a clock when the absolute value of the received differential voltage |Vin,p−Vin,n| is larger than the difference of the reference voltage |Vrefh−Vrefl|.

The clock restoring circuit 67 generates a clock Rclk used for the sampling of the data signal from the received clock signal CLK. The clock restoring circuit 67 may be, for example, a PLL (phase locked loop) or a DLL (delay locked loop), and generate the clock Rclk having a high frequency used for the sampling of the data signal from the received clock signal CLK having a low frequency. When the frequency of the received clock sign CLK is identical to that of the data signal, the receiving unit 61 is not required to include the clock restoring circuit 67, and in this case, the clock signal CLK being output from the multi-level detector 66 is directly input to the sampler 68.

The sampler 68 performs a sampling of the data Rdata to be output using the clock Rclk used for the sampling. In addition, the sampler 68 may convert the sampled data to a parallel data. When each of R, G, B has a depth of 8 bits, parallel data of 24 bits may be output.

The data aligning unit 69 is necessary when the parallel data is not aligned to time so that an instant at which the parallel data is changed concurs.

The shift register 62 sequentially shifts the received start pulse SP to be output.

The data latch 63 sequentially stores the image data being output from the receiving unit according to a signal from the shift register 62, and then outputs the image data in parallel. For example, the data latch 63 sequentially stores a data corresponding to a portion of a single row line and then outputs the data in parallel.

The DAC 64 converts a digital signal being output by the data latch to an analog signal.

The above-described shift register 62, data latch 63 and DAC 64 have configurations similar to the case when the conventional RSDS is used. However, while the column driver integrated circuit employing the conventional RSDS has an operating frequency of a pixel frequency f, the column driver integrated circuit in accordance with the present invention have an lower operating frequency of f/N (where N is the number of the column driver integrated circuit). This facilitates an application of a cyclic DAC.

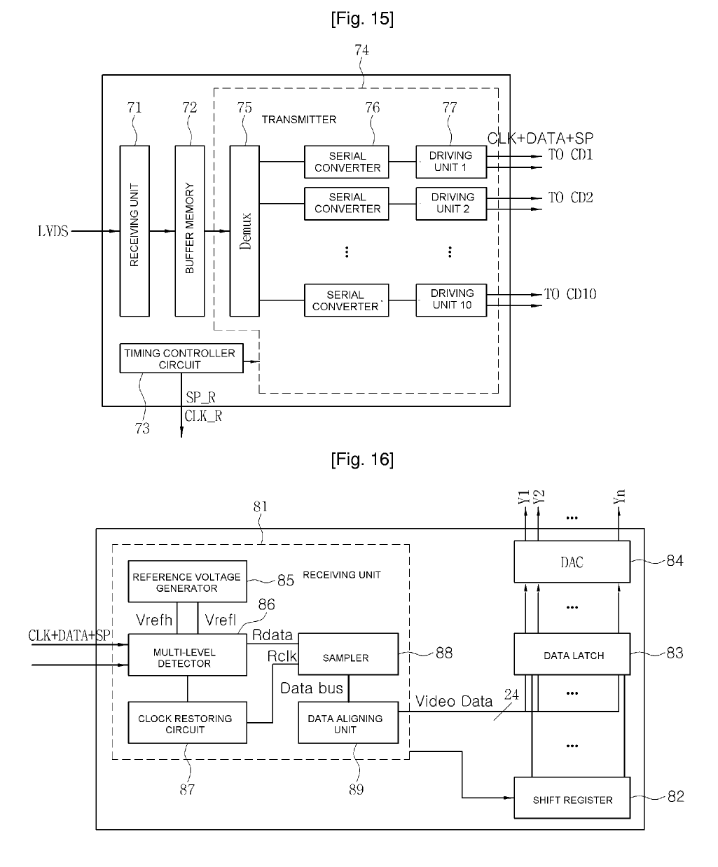

FIG. 15 is a diagram illustrating another example of a timing controller that can be used for the display of FIG. 5 or FIG. 11. The example exemplifies a case where the start pulse is transmitted through the differential pair. The timing controller of FIG. 15 is similar to that of FIG. 13 except that the start pulse is transmitted through the differential pair. Therefore, the description will be focused on the difference.

Referring to FIG. 15, the timing controller comprises a receiving unit 71, a buffer memory 72, a timing controller circuit 73 and a transmitter 74. The timing controller circuit 73 receives a reception control signal converted to a TTL signal to generate a start pulse SP_R and a clock signal CLK_R which are transmitted to a row driving integrated circuit. The timing controller circuit 73 also generates signals corresponding to a start pulse SP and a clock signal CLK which are transmitted to a column driving integrated circuit.

The transmitter 74 receives an image data being output from the buffer memory 72 and the start pulse SP and the clock signal CLK being output from the timing controller circuit 73, and outputs a control signal including the start pulse SP, the clock signal CLK and a data signal DATA. The control signal, the clock signal CLK and the data signal DATA are transmitted through the single differential pair for each column driver integrated circuit. The clock signal CLK is embedded between the data signal DATA to have a different signal magnitude and the control signal is transmitted using a polarity of the clock signal CLK or as a part of the data signal DATA.

The transmitter 74 comprises a demultiplexer 75, a serial converter 76 a driving unit 77. The serial converter 76 sequentially outputs a clock bit, the image data being output from the demultiplexer 75, and the control signal including the start pulse to the driving unit 77. For example, when a clock tail similar to the clock tail shown in FIG. 10 is used, the serial converter 76 outputs an image DATAn-1, the clock bit having the polarity identical to that of the image DATAn-1, a clock tail bit (dummy bit) having the polarity identical to that of the image DATAn-1, and an image DATA 0. When a single clock signal is embedded for each image data corresponding to a single pixel, a depth of each of RGB is 8 bit, and the clock tail is used as shown in FIG. 10, a data being output from the serial converter 76 which includes the clock bit, clock tail, the control bit and 24 bits of image data, 27 bits in total, is transmitted to the driving unit 77 per clock. In addition, when the clock tail bit is not used, a signal including the clock bit, the control bit and 24 bits of image data, 26 bits in total, may be transmitted to the driving unit 77 for every clock, and when the control signal is transmitted using the polarity of the clock signal, a signal of 25 bits may be transmitted to the driving unit 77 for every clock.

As described above, when the signal including the clock bit, clock tail, the control bit and 24 bits of image data, 27 bits in total, is received, a signal of the clock bit is converted to have a different magnitude from the clock tail, the control bit and the image data, and when a signal including the clock bit, the control bit and 24 bits of image data, 26 bits in total, is received, the signal of the clock bit is converted to have a different magnitude from the control bit and the image data. In addition, as described above, when the control bit is transmitted using the polarity of the clock bit, the control bit is converted to have a different magnitude from the image data.

FIG. 16 is a diagram illustrating another example of a column driver integrated circuit that can be used for the display of FIG. 5 or FIG. 11. The example exemplifies the case where the start pulse is transmitted through the differential pair. The column driver integrated circuit of FIG. 16 is similar to that of FIG. 14 except that the start pulse is transmitted through the differential pair. Therefore, the description will be focused on the difference.

Referring to FIG. 16, the column driver integrated circuit comprises a receiving unit 81, a shift register 82, data latch 83 and a DAC (digital-to-analog converter) 84. The receiving unit 81 restores the data signal DATA and the clock signal CLK from the signal transmitted through the single differential pair. Since the control signal including the start pulse is also transmitted through the differential pair, the receiving unit 81 obtains and outputs the control signal from the polarity of the clock signal CLK or restores and outputs the control signal transmitted as a part of the data signal DATA.

The receiving unit 81 comprises a reference voltage generator 85, a multi-level detector 86 and a sampler 88. In addition, the receiving unit 81 may further comprise a clock restoring circuit 87 and a data aligning unit 89. The sampler 88 performs a sampling of the data signal Rdata and the control signal to be output using the clock Rclk used for the sampling. As described above, the control signal may be obtained form the polarity of the clock signal or the part of the data signal. The obtained control signal is transmitted to the shift register 82.

Since the timing controller and the column driver integrated circuit shown in FIGS. 15 and 16 transmits the control signal such as the start pulse as well as the image data and the clock signal through the differential pair, compared to the timing controller and the column driver integrated circuit shown in FIGS. 13 and 14, a signal line for the star pulse may not be used. Therefore, the wiring of a display may be simplified.

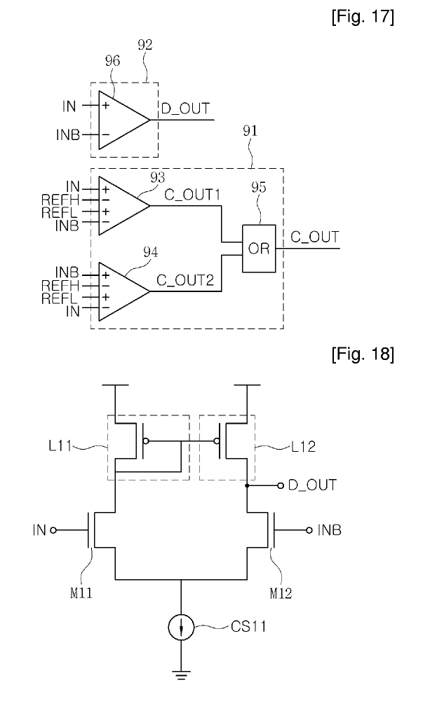

FIG. 17 is a diagram illustrating an example of a multi-level detector that may be employed by the column driving integrated circuit of FIG. 14 or 16. Referring to FIG. 17, the multi-level detector comprises a clock detector 91 and a data detector 92.

The clock detector 91 outputs a clock having a logic value of 0 or 1 according to a result of a comparison of voltages VIN and VINB of differential signals IN, INB with voltages VREFH and VREFL of reference signals REFH and REFL. In case a magnitude of a received clock signal is larger than that of a data signal as shown in FIG. 7, the clock detector 91 outputs the logic value of 1 when VIN is larger than VREFH and VINB is smaller than VREFL or when VINB is larger than VREFH and VIN is smaller than VREFL, or otherwise the clock detector 91 outputs the logic value of 0. In this case, the logic value of 1 means that a high level clock signal is received, and the logic value of 0 means that a low level signal is received. In case the clock is generated in this manner, when whether the received signal being the received clock signal or the received data signal is ambiguous such as when VIN is larger than VREF and VINB is also larger than VREFL, the logic value of 0 is output so that the received signal is decided to be not the received clock signal. Therefore, when the case that whether the received signal is the received clock signal or the received data signal is ambiguous is interpreted as the received clock signal, the clock detector 91 outputs the logic value of 0 when VIN is smaller than VREFH and VINB is larger than VREFL, and VINB is smaller than VREFH and VIN is larger than VREFL, or otherwise the clock detector 91 outputs the logic value of 1.

In case a magnitude of the embedded clock signal is smaller than that of the data signal as shown in FIG. 8, the clock detector 91 outputs the logic value of 1 when VIN is smaller than VREFH and VINB is larger than VREFL, and VINB is smaller than VREFH and VIN is larger than VREFL, or otherwise the clock detector 91 outputs the logic value of 0. In this case, the logic value of 1 means that a low level clock signal is received, and the logic value of 0 means that a high level signal is received. As described above, when the case whether the received signal being the received clock signal or the received data signal is ambiguous and is interpreted as the received clock signal, the logic value of 0 is output when VIN is larger than VREFH and VINB is smaller than VREFL or when VINB is larger than VREFH and VIN is smaller than VREFL, or otherwise the clock detector 91 outputs the logic value of 1. Since it is obvious to the skilled in the art that configurations of other clock detectors is anticipated from a configuration of the clock detector of one of FIG. 7 and FIG. 8, description will be focused on a case where the logic value of 1 is output when VIN is larger than VREFH and VINB is smaller than VREFL or when VINB is larger than VREFH and VIN is smaller than VREFL or otherwise the logic value of 0 is output.

As shown the clock detector 91 may comprise a first comparator 93 and a second comparator 94. The first comparator 93 outputs the logic value of 1 when VIN is larger than VREFH and VINB is smaller than VREFL or otherwise the logic value of 0 is output. The second comparator 94 outputs the logic value of 1 when VINB is larger than VREFH and VIN is smaller than VREFL or otherwise the logic value of 0 is output. An arithmetic unit 95 performing OR operation receives outputs of the first comparator 93 and the second comparator 94, performs an OR operation and outputs a result thereof. When the first comparator 93 outputs the logic value of 0 is output when VIN is larger than VREFH and VINB is smaller than VREFL or otherwise the logic value of 1 is output and the second comparator 94 outputs the logic value of 0 when VINB is larger than VREFH and VIN is smaller than VREFL or otherwise the logic value of 1, a AND or NAND operator may be used as arithmetic unit 95.

The data detector 92 performs a comparison of the voltages VIN and VINB of the differential input signals IN and INB received from the timing controller to output a data having a logic value of 0 or 1 according to a result of the comparison. That is, the data detector outputs a sign of the differential input signals IN and INB. In accordance with this embodiment, the logic value of 1 is output when VIN is larger than VINB, and the logic value of 0 is output when VIN is smaller than VINB. The data detector 92 may be embodied using a third comparator 96 as shown.

FIG. 18 is a diagram illustrating an example of a third comparator of FIG. 17.

Referring to FIG. 18, the third comparator 96 comprises a current source CS11, a first transistor M11, a second transistor M12, a first load L11, and a second load L12. The current source CS11 is connected to sources of the first and the second transistors M11 and M12 so that a predetermined current flows therebetween. The current source CS11 may be embodied in various ways such as by using a transistor having a predetermined voltage applied to its gate. the first transistor M11 is connected between the first load L11 and the current source CS11 so that a current path is formed between the first load L11 and the current source CS11 according to a first received signal IN. the second transistor M12 is connected between the second load L12 and the current source CS11 so that a current path is formed between the second load L12 and the current source CS11 according to a second received signal INB. A power supply voltage is applied to one end of the first load L11, and the other end is connected to a drain of the first transistor M11. The power supply voltage is applied to one end of the second load L12, and the other end is connected to a drain of the second transistor M12. A voltage drop occurs at the first load L11 and the second load L12 according to a current flowing therethrough. The first load L11 and the second load L12 may be embodied in various ways such as by a transistor as shown.

As shown, since the current path is formed at the first transistor M11 and the current path is not formed at the second transistor M12 when a voltage of the first received signal IN is larger than that of the second received signal INB, the voltage drop does not occur at the second load L12. Therefore, in this case, an output D_OUT has a high level voltage having a logic value of 1. Similarly, when the voltage of the first received signal IN is smaller than that of the second received signal INB, the output D_OUT has a low level voltage having a logic value of 0.

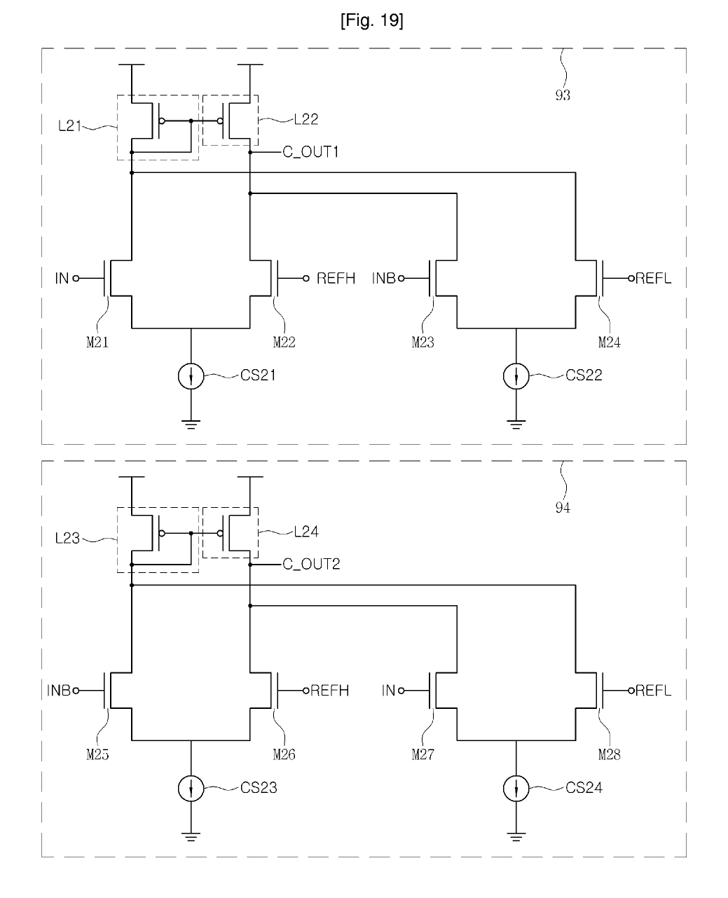

FIG. 19 is a diagram illustrating an example of the first and the second comparators of FIG. 17.

Referring to FIG. 19, the first comparator 93 comprises a first current source CS21, a second current source CS22, a first through a fourth transistor M21, M22, M23 and M24, a first load L21 and a second load L22. The first current source CS21 is connected to sources of the first and the second transistors M21 and M22 so that a predetermined current flows therebetween. The second current source CS21 is connected to sources of the third and the fourth transistors M23 and M24 so that a predetermined current flows therebetween. The first transistor M21 is connected between the first load L21 and the first current source CS21 so that a current path is formed between the first load L21 and the first current source CS21 according to the first received signal IN applied to a gate thereof. The second transistor M22 is connected between the second load L22 and the first current source CS21 so that a current path is formed between the second load L22 and the first the current source CS21 according to a first reference signal REFH applied to a gate thereof. The third transistor M23 is connected between the second load L22 and the second current source CS22 so that a current path is formed between the second load L22 and the second the current source CS22 according to the second received signal INB applied to a gate thereof. The fourth transistor M24 is connected between the first load L21 and the second current source CS22 so that a current path is formed between the first load L22 and the second current source CS22 according to a second reference signal REFL applied to a gate thereof. A power supply voltage is applied to one end of the first load L21, and the other end is connected to drains of the first and the fourth transistors M21 and M24. The power supply voltage is applied to one end of the second load L22, and the other end is connected to drains of the second and the third transistors M22 and M23.

As shown, since the current path is not formed at the second transistor M22 and the third transistor M23 when a voltage of the first received signal IN is larger than that of the first reference signal REFH and a voltage of the second received signal INB is smaller than that of the second reference signal REFL, the voltage drop does not occur at the second load L22. Therefore, in this case, an output C_OUT has a high level voltage having a logic value of 1. Since a current path is formed at at least one of the second transistor M22 and the third transistor M23 in other cases, the voltage drop occurs at the second load L22. Therefore, the output C_OUT has a low level voltage having a logic value of 0.

The second comparator 94 comprises a third current source CS23 and a fourth current source CS24, a fifth through an eighth transistors M25, M26, M27 and M28, a third load L23 and a fourth load L24. A configuration of the second comparator is similar to the first comparator except that terminals through which the first received signal IN and the second received signal INB are input are exchanged. Therefore, a detailed description is omitted.

In accordance with the second comparator, the output C_OUT is a high level voltage having the logical value of 1 when a voltage of the second received signal INB is larger than that of the first reference signal REFH and a voltage of the first received signal IN is smaller than that of the second reference signal REFL. Otherwise, the output C_OUT is a low level voltage having the logical value of 0.

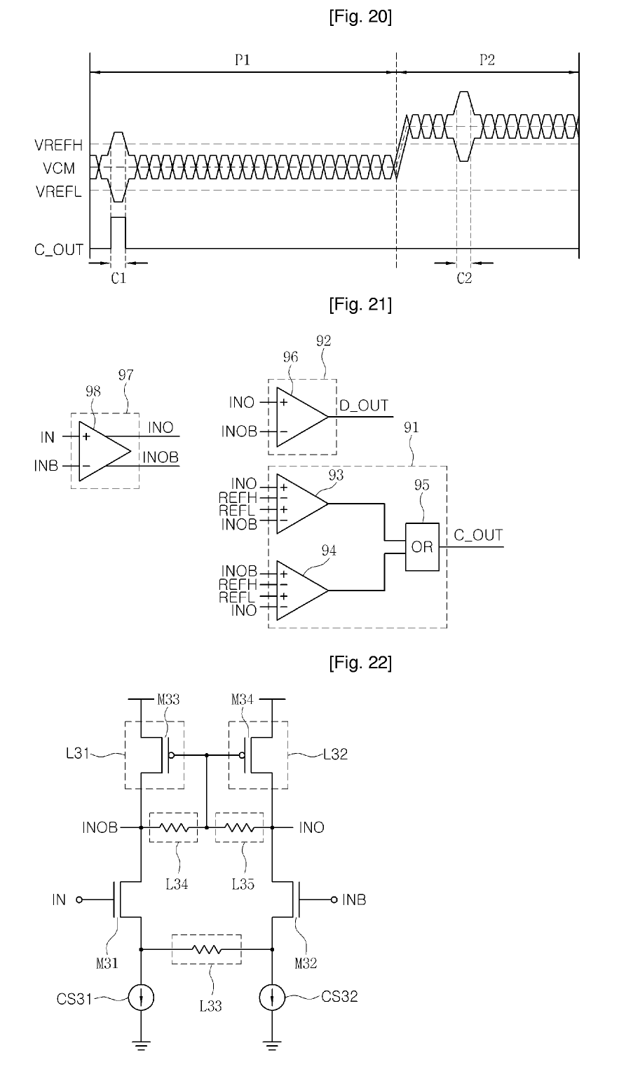

The multi-level detector included in the column driving integrated circuit may detect and output the data and the clock by having one of configurations shown in FIGS. 17 through 19. However, the multi-level detector having the configuration may malfunction when there is a common mode as shown in FIG. 20.

Specifically, as shown in FIG. 20, since a common mode voltage VCM of the received signal is consistent with an average of the voltages VREFH and VREFL of the reference signal, i.e. a common mode voltage of the reference signal during a first period P1, of received signals during a clock signal embedded period C1, a signal having a higher voltage is higher than VREFH and a signal having a lower voltage is lower than VREFL. Therefore, the clock output C_OUT has a logic value of 1 during the clock signal embedded period C1, and the clock output C_OUT has a logic value of 0 during a period other than the period C1 of the period P1.

However, since the common mode voltage VCM of the received signal is much higher than the average of the voltages VREFH and VREFL of the reference signal during a second period P2, of received signals during a clock signal embedded period C2, the signal having a higher voltage is higher than VREFH while the signal having a lower voltage is higher than VREFL contrary to the first period. In this case, the comparators of FIG. 19 cannot recognize the received signal as the clock signal so that the clock output C_OUT has the logical value of 0. Therefore, the multi-level detectors shown in FIGS. 17 through 19 are disadvantageous in that the clock signal embedded in the received signal cannot be detected.

FIG. 21 is a diagram illustrating another example of a multi-level detector that may be employed by the column driving integrated circuit of FIG. 14 or 16, wherein a malfunction of the multi-level detector does not occur even when a received signal has a common mode, i.e. when a voltage of the common mode of the received signal does not concur with a common mode of a reference signal.

Referring to FIG. 21, the multi-level detector comprises a first common mode removing circuit 97, a clock detector 91 and a data detector 92.

The first common mode removing circuit 97 removes the common mode of the received signals IN and INB. The “removal of the common mode” refers not only to a common mode voltage of output signals INO, INOB being 0 but also to the common mode voltage of the output signals INO, INOB having a unique value depending on the first common mode removing circuit 97. Therefore, the first common mode removing circuit 97 receives the signals IN and INB to output differential signals INO and INOB having a predetermined common mode voltage. The first common mode removing circuit 97 may be embodied using a differential amplifier 98. however, when a gain of the differential amplifier 98 is too large, the output signals INO and INOB converges to a voltage of a voltage source so that the clock signal and the data signal cannot be distinguished. Therefore, it should be noted that the differential amplifier 98 has a proper gain.

A configuration of the clock detector 91 is identical to that of the clock detector shown in FIG. 17. However, the clock detector of FIG. 17 receives the signals IN and INB while the clock detector 91 of FIG. 21 receives the output signals INO and INOB of the first common mode removing circuit 97. the clock detector 91 of FIG. 21 is advantageous in that the clock detector 91 of FIG. 21 operates without an error even when the received signals IN and INB have a common mode by receiving the output signals INO, INOB which is removed of the common mode of the received signals IN and INB.

A configuration of the data detector 92 is identical to that of the data detector shown in FIG. 17. However, an input to the data detector 92 may be the output signals INO and INOB of the first common mode removing circuit 97 as shown in FIG. 21 or the received signals IN and INB as shown in FIG. 17.

FIG. 22 is a diagram illustrating an example of a first common mode removing circuit of FIG. 21. While the first common mode removing circuit may be embodied in a manner shown in FIG. 22, the first common mode removing circuit may be embodied using the amplifier shown in FIG. 18. However, since the first common mode removing circuit is a differential amplifier, the first common mode removing circuit differs in that INOB is output through a drain of the first transistor M11 and INO is output through a drain of the second transistor M12. In addition, the first common mode removing circuit requires a lower gain compared to that of the amplifier shown in FIG. 18 because the output signal may converge to the voltage of the voltage source when the gain is large.

Referring to FIG. 22, the first common mode removing circuit comprises a first current source CS31 and a second current source CS32, a first transistor M31 and a second transistor M32, and a first through a fifth loads L31, L32, L33, L34 and L35.

The first current source CS31 is connected to a source of the first transistor M31, and the second current source CS32 to a source of the second transistor M32. The first current and the second sources CS31 and C32 may be embodied in various manners such as by a transistor having a predetermined voltage applied to its gate.

The first transistor M31 is connected between the first load L31 and the current source CS31 so that a current path is formed between the first load L31 and the first current source CS31 according to the first received signal IN applied to a gate thereof. The second transistor M32 is connected between the second load L32 and the second current source CS32 so that a current path is formed between the second load L32 and the second the current source CS32 according to a second received signal INB applied to a gate thereof.

A power supply voltage is applied to one end of the first load L31, and the other end is connected to a drain of the first transistor M31. The power supply voltage is applied to one end of the second load L32, and the other end is connected to a drain of the second transistor M32. A voltage drop occurs at the first load L31 and the second load L32 according to a current flowing therethrough. The first load L31 and the second load L32 may be embodied in various ways such as by transistors M33 and M34 having their gates interconnected as shown.

The third load L33 is connected between the sources of the first and the second transistors M31 and M32 to increase a linearity of the differential amplifier.

The fourth load L34 is connected between the drain and the gate of the third transistor M33, and the fifth load L35 is connected between the drain and the gate of the fourth transistor M34. The fourth and the fifth loads L34 and L35 are load resistors and perform a function of improving a common mode rejection ratio by feeding back the common mode.

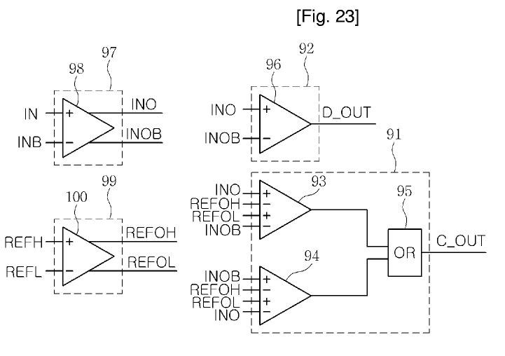

FIG. 23 is a diagram illustrating another example of a multi-level detector that may be employed by the column driving integrated circuit of FIG. 14 or 16, wherein the multi-level detector which removes the common mode of the reference signal as well as the received signal and then detects a clock signal is illustrated.

Referring to FIG. 23, the multi-level detector comprises the first common mode removing circuit 97, a second common mode removing circuit 99, a clock detector 91 and a data detector 92. A function and an operation of the first common mode removing circuit 97 are identical to those of the first common mode removing circuit of FIG. 21. Therefore, a detailed description is omitted.

The second common mode removing circuit 99 removes a common mode of reference signals REFH and REFL. A configuration of a differential amplifier 100 included in the second common mode removing circuit 99 is identical to that of the differential amplifier 98 included in the first common mode removing circuit 97. Preferably, length to width ratios of the first common mode removing circuit 97 and the second common mode removing circuit 99, a current-voltage characteristic of the load and a current value of the current source are identical.

A configuration of the clock detector 91 is identical to that of the clock detector shown in FIG. 21. However, while the clock detector of FIG. 21 receives the reference signals REFH and REFL, the clock detector 91 of FIG. 23 receives output signals REFOH and REFOL of the second common mode removing circuit 99.

A configuration of the data detector 92 is identical to that of the clock detector shown in FIG. 21.

In accordance with the multi-level detector of FIG. 23, the reason the second common mode removing circuit 99 is necessary is that it is difficult match the common mode voltage of the reference signal to that a common mode voltage of outputs INO and INOB of the first common mode removing circuit without using the second common mode removing circuit 99 since the common mode voltage of outputs INO and INOB of the first common mode removing circuit may vary according to a current applied to a current source, a voltage of a voltage source or a process condition. Therefore, the multi-level detector of FIG. 23 is advantageous over that of FIG. 21 in that the common modes of the received signals IN and INB and the reference signals REFH and REFL can be made more identical to each other.

### INDUSTRIAL APPLICABILITY

In accordance with the above description, the display panel of the present invention includes various display panels wherein the present invention may be used such as a TFT-LCD (TFT Liquid Crystal Display), a STN-LCD, a Ch-LCD, a FLCD (Ferroelectric Liquid Crystal Display), a PDP (Plasma Display Panel), an OELD (Organic Electro-Luminescence Display) and FED.

While the description of the present invention is focused on a configuration where a single differential pair is connected between the timing controller and the column driving integrated circuit, the scope of the present invention does not exclude a configuration where two or more differential pairs are connected between the timing controller and the column driving integrated circuit.

While description of the present invention is focused on the multi-level detectors shown in FIGS. 17, 21 and 22 used for detecting a multi-level in a display using a multi-level signaling having a clock signal embedded therein, the use of the multi-level detector is not limited thereto. That is, the multi-level detectors shown in FIGS. 17, 21 and 22 may be used for a general multi-level signaling as well as the multi-level signaling having the clock signal embedded therein.

While the present invention has been particularly shown and described with reference to the preferred embodiment thereof and drawings, it will be understood by those skilled in the art that various changes in form and details may be effected therein without departing from the spirit and scope of the invention as defined by the appended claims.

1. A multi-level detector comprising:
a first common mode removing circuit configured to receive a first differential multi-level signal, wherein the first differential multi-level signal comprises a first signal and a second signal, wherein the first common mode removing circuit is configured to output a second differential multi-level signal, wherein the second differential multi-level signal comprises a third signal and a fourth signal, and wherein the second differential multi-level signal is generated by removing a common mode of the first differential multi-level signal;
a first comparator configured to receive the second differential multi-level signal and a differential reference signal, wherein the differential reference signal comprises a first reference signal and a second reference signal, wherein the second reference signal has a voltage level lower than the first reference signal, wherein the first comparator is configured to output one of two logic values according to a result of a comparison of a voltage level of the third signal and a voltage level of the first reference signal and to a result of a comparison of a voltage level of the fourth signal and a voltage level of the second reference signal;
a second comparator configured to receive the second differential multi-level signal and the differential reference signal, wherein the second comparator is configured to output one of the two logic values according to a result of a comparison of the voltage level of the fourth signal and the voltage level of the first reference signal and to a result of a comparison of the voltage level of the third signal and the voltage level of the second reference signal; and
an arithmetic unit configured to output a multi-level detection result, wherein the multi-level detection result is a result of a logic operation of outputs of the first comparator and the second comparator.

2. The multi-level detector in accordance with claim 1, wherein the first common mode removing circuit comprises:
a first transistor configured to receive the first signal through a gate of the first transistor, wherein the first transistor is configured to output the fourth signal through a drain of the first transistor;
a second transistor configured to receive the second signal through a gate of the second transistor, wherein the second transistor is configured to output the third signal through a drain of the second transistor thereof;
a current source connected to sources of the first transistor and the second transistors;
a first load connected between the drain of the first transistor and a voltage source; and
a second load connected between the drain of the second transistor and the voltage source.

3. The multi-level detector in accordance with claim 1, wherein the first common mode removing circuit comprises:
a first transistor configured to receive the first signal through a gate of the first transistor, wherein the first transistor is configured to output the fourth signal through a drain of the first transistor;
a second transistor configured to receive the second signal through a gate of the second transistor, wherein the second transistor is configured to output the third signal through a drain of the second transistor;
a first current source connected to a source of the first transistor;
a second current source connected to a source of the second transistor;
a first load connected between the drain of the first transistor and a voltage source;
a second load connected between the drain of the second transistor and the voltage source; and
a third load connected between the sources of the first and the second transistors.

4. The multi-level detector in accordance with claim 1, wherein the first common mode removing circuit comprises:
a first transistor configured to receive the first signal through a gate of the first transistor, wherein the first transistor is configured to output the fourth signal through a drain of the first transistor;
a second transistor configured to receive the second signal through a gate of the second transistor, wherein the second transistor is configured to output the third signal through a drain of the second transistor thereof;
a first current source connected to a source of the first transistor;
a second current source connected to a source of the second transistor;
a third transistor connected between the drain of the first transistor and a voltage source;
a fourth transistor connected between the drain of the second transistor and the voltage source, wherein a gate of the fourth transistor is connected to a gate of the third transistor;
a third load connected between the sources of the first transistor and the source of the second transistor;
a fourth load connected between a drain and a gate of the third transistor; and
a fifth load connected between a drain and a gate of the fourth transistor.

5. The multi-level detector in accordance with claim 1, wherein:
the first comparator is configured to outputs a first logic value of the two logic values when the voltage level of the third signal is higher than the voltage level of the first reference signal and the voltage level of the fourth signal is lower than the voltage level of the second reference signal or otherwise outputs a second logic value of the two logic values, and
the second comparator is configured to outputs the first logic value when the voltage level of the fourth signal is higher than the voltage level of the first reference signal and the voltage level of the third signal is lower than the voltage level of the second reference signal or otherwise outputs the second logic value.

6. The multi-level detector in accordance with claim 5, wherein the arithmetic unit is configured to outputs the multi-level detection result indicating high level when at least one of the first comparator and the second comparators outputs the first logic value or otherwise outputs the multi-level detection result indicating low level.

7. The multi-level detector in accordance with claim 1, wherein:
the first comparator is configured to outputs a first logic value of the two logic values when the voltage level of the third signal is lower than the voltage level of the first reference signal and the voltage level of the fourth signal is higher than the voltage level of the second reference signal or otherwise outputs a second logic value of the two logic values, and
the second comparator outputs the first logic value when the voltage level of the fourth signal is lower than the voltage level of the first reference signal and the voltage level of the third signal is higher than the voltage level of the second reference signal or otherwise and outputs the second logic value.

8. The multi-level detector in accordance with claim 7, wherein the arithmetic unit is configured to outputs the multi-level detection result indicating low level when the first comparator and the second comparators output the first logic value or otherwise outputs the multi-level detection result indicating high level.

9. The multi-level detector in accordance with claim 1, further comprising a second common mode removing circuit configured to receive the second differential reference signal, wherein the second common mode removing circuit is configured to output the first differential reference signal generated by removing a common mode of the second differential reference signal.

10. The multi-level detector in accordance with claim 9, wherein a configuration of the second common mode removing circuit is substantially identical to the configuration of the first common mode removing circuit.

11. The multi-level detector in accordance with claim 1, further comprising a third comparator configured to output a sign detection result having the two logic values according to a comparison result of the voltage level of the first signal and the voltage level of the second signal.

12. The multi-level detector in accordance with claim 1, further comprising a third comparator configured to output a sign detection result having the two logic values according to a comparison result of the voltage level of the third signal and the voltage level of the fourth signal.

13. A multi-level detecting method, comprising steps of:
removing a common mode of a received differential multi-level signal; and
outputting a result of a comparison between the received differential multi-level signal having the common mode thereof removed and a voltage level of a first differential reference signal.

14. The method in accordance with claim 13, further comprising forming the first differential reference signal by removing a common mode of a second differential reference signal.

15. The method in accordance with claim 13, further comprising outputting a sign of the received differential multi-level signal or the received differential multi-level signal having the common mode removed.

16. The method in accordance with claim 15, wherein, in said outputting a result of a comparison between the received differential multi-level signal having the common mode removed and a voltage level of a first differential reference signal, a logic value indicating the received differential multi-level signal is a high level signal is output when:
VINO is larger than VREFH and VINOB is smaller than VREFL;
VINOB is larger than VREFH and VINO is smaller than VREFL; or
a logic value indicating the received differential multi-level signal is a low level signal is otherwise output, wherein VINO and VINOB are voltages of the received differential multi-level signal having the common mode removed, and wherein VREFH and VREFL are a high voltage and a low voltage of the first differential reference signal respectively.

17. The method in accordance with claim 15, wherein, in said outputting a result of a comparison between the received differential multi-level signal having the common mode removed and a voltage level of a first differential reference signal, a logic value indicating the received differential multi-level signal is a low level signal is output when:
VINO is smaller than VREFH and VINOB is larger than VREFL and VINOB is smaller than VREFH and VINO is larger than VREFL; or
a logic value indicating the received differential multi-level signal is a high level signal is otherwise output, wherein VINO and VINOB are voltages of the received differential multi-level signal having the common mode removed, and wherein VREFH and VREFL are a high voltage and a low voltage of the first differential reference signal respectively.

18. A column driving integrated circuit comprising a shift register, a data latch and a DAC, wherein the integrated circuit comprising:
a first common mode removing circuit configured to receive a first differential signal and output a second differential signal, wherein the second differential signal is generated by removing a common mode of the received first differential signal, wherein the received first differential signal comprises a first signal and a second signal, wherein the output second differential signal comprises a third signal and a fourth signal;
a data detecting unit configured to output a received data signal corresponding to a sign of the received first differential signal or the output second differential signal;
a clock detecting unit configured to output a received clock signal, wherein the received clock signal is a result of a comparison between voltages of the second differential signal and a first differential reference signal, wherein the first differential reference signal comprises a first reference signal and a second reference signal, and wherein the second reference signal has a voltage level lower than the first reference signal; and
a sampler configured to perform sampling of the received data signal using the received clock signal to transmit a sampled result to the shift register.

19. The column driving integrated circuit in accordance with claim 18, wherein the first common mode removing circuit comprises a differential amplifier.

20. The column driving integrated circuit in accordance with claim 18, wherein the first common mode removing circuit comprises:
a first transistor configured to receive the first signal through a gate of the first transistor, wherein the first transistor is configured to output the fourth signal through a drain of the first transistor;
a second transistor configured to receive the second signal through a gate of the second transistor, wherein the second transistor is configured to output the third signal through a drain of the second transistor thereof;
a current source connected to sources of the first transistor and the second transistors;
a first load connected between the drain of the first transistor and a voltage source; and
a second load connected between the drain of the second transistor and the voltage source.

21. The column driving integrated circuit in accordance with claim 18, wherein the first common mode removing circuit comprises:
a first transistor configured to receive the first signal through a gate of the first transistor, wherein the first transistor is configured to output the fourth signal through a drain of the first transistor;
a second transistor configured to receive the second signal through a gate of the second transistor, wherein the second transistor is configured to output the third signal through a drain of the second transistor;
a first current source connected to a source of the first transistor;
a second current source connected to a source of the second transistor;
a first load connected between the drain of the first transistor and a voltage source;
a second load connected between the drain of the second transistor and the voltage source; and
a third load connected between the sources of the first and the second transistors.

22. The column driving integrated circuit in accordance with claim 18, wherein the first common mode removing circuit comprises:
a first transistor configured to receive the first signal through a gate of the first transistor, wherein the first transistor is configured to output the fourth signal through a drain of the first transistor;
a second transistor configured to receive the second signal through a gate of the first transistor, wherein the first transistor is configured to output the third signal through a drain of the second transistor;
a first current source connected to a source of the first transistor;
a second current source connected to a source of the second transistor;
a third transistor connected between the drain of the first transistor and a voltage source;
a fourth transistor connected between the drain of the second transistor and the voltage source, wherein a gate of the fourth transistor is connected to a gate of the third transistor;
a third load connected between the sources of the first transistor and the second transistor;
a fourth load connected between a drain and the gate of the third transistor; and
a fifth load connected between a drain and the gate of the fourth transistor.

23. The column driving integrated circuit in accordance with claim 18, wherein the clock detecting unit outputs a first logic value of two logic values when:
the voltage level of the third signal is higher than the first reference signal and the voltage level of the fourth signal is lower than the second reference signal;
the voltage level of the fourth signal is higher than the first reference signal and the voltage level of the third signal is lower than the second reference signal; or
a second logic value of the two logic values is otherwise output.

24. The column driving integrated circuit in accordance with claim 18, wherein the clock detecting unit outputs a first logic value of two logic values when:
the voltage level of the third signal is lower than the first reference signal and the voltage level of the fourth signal is higher than the second reference signal and the voltage level of the fourth signal is lower than the first reference signal and the voltage level of the third signal is higher than the second reference signal; or
a second logic value of the two logic values is otherwise output.

25. The column driving integrated circuit in accordance with claim 18, wherein the clock detecting unit comprises:
a first comparator configured to output one of two logic values according to a result of a comparison of a voltage level of the third signal and the voltage level of the first reference signal and to a result of a comparison of a voltage level of the fourth signal and a voltage level of the second reference signal;
a second comparator for outputting one of the two logic values according to a result of a comparison of the voltage level of the fourth signal and the voltage level of the first reference signal and to a result of a comparison of the voltage level of the third signal and the voltage level of the second reference signal; and
an arithmetic unit configured to output the clock signal, wherein the clock signal is a result of a logic operation of outputs of the first comparator and the second comparator.

26. The column driving integrated circuit in accordance with claim 18, further comprising a second common mode removing circuit configured to output the first differential reference signal generated by removing a common mode of a second differential reference signal.

27. The column driving integrated circuit in accordance with claim 26, wherein a configuration of the second common mode removing circuit is substantially identical to the first common mode removing circuit.

28. The column driving integrated circuit in accordance with claim 18, further comprising a clock restoring circuit configured to increase a frequency of the received clock signal so that the sampler performs the sampling at the increased frequency.

29. A display comprising a timing controller, a plurality of column driving integrated circuits, at least one row driving integrated circuit and a display panel, wherein the plurality of column driving integrated circuits include a column driving integrated circuit in accordance with claim 18.
